(19) United States
(12) Patent Application Publication
(10) Pub. No.: US 2023/0323814 A1
(43) Pub. Date: Oct. 12, 2023

(54) HYDROGEN TURBINE POWER ASSISTED CONDENSATION

(71) Applicant: Raytheon Technologies Corporation, Farmington, CT (US)

(72) Inventors: Neil J. Terwilliger, Cheshire, CT (US); Joseph B. Staubach, Colchester, CT (US); Joseph E. Turney, Amston, CT (US)

(21) Appl. No.: 18/192,965

(22) Filed: Mar. 30, 2023

Related U.S. Application Data
(60) Provisional application No. 63/329,032, filed on Apr. 8, 2022.

(51) Int. Cl. F02C 7/12; B01D 53/26

(52) U.S. Cl. CPC F02C 7/12; B01D 53/265; F05D 2270/303; B01D 2257/80

(57) ABSTRACT

Aircraft engines and methods of operation include a core assembly having a compressor section, a burner section, and a turbine section arranged along a shaft, with a core flow path through the turbine engine such that exhaust from the burner section passes through the turbine section. A core condenser is arranged downstream of the turbine section of the core assembly along the core flow path, the core condenser being configured to condense water from the core flow path. A refrigeration system is operably coupled to the core condenser and configured to direct a cold stream flow path into thermal interaction with the core flow path at the core condenser and configured to control a delta temperature at which heat exchange occurs between the core flow path and the cold stream flow path.

### CROSS-REFERENCE TO RELATED APPLICATIONS

This application claims the benefit of U.S. Provisional Application No. 63/329,032 filed Apr. 8, 2022, the disclosure of which is incorporated herein by reference in its entirety.

### TECHNICAL FIELD

The present disclosure relates generally to turbine engines and aircraft engines, and more specifically to aircraft engines that may include power assisted systems for condensation of water from a core flow.

### BACKGROUND

Gas turbine engines, such as those utilized in commercial and military aircraft, include a compressor section that compresses air, a combustor section in which the compressed air is mixed with a fuel and ignited, and a turbine section across which the resultant combustion products are expanded. The expansion of the combustion products drives the turbine section to rotate. As the turbine section is connected to the compressor section via a shaft, the rotation of the turbine section drives the compressor section to rotate. In some configurations, a fan is also connected to the shaft and is driven to rotate via rotation of the turbine.

Typically, hydrocarbon-based fuel is employed for combustion onboard an aircraft, in the gas turbine engine. The liquid fuel has conventionally been a hydrocarbon-based fuel. Alternative fuels have been considered, but suffer from various challenges for implementation, particularly on aircraft. Hydrogen-based and/or methane-based fuels are viable effective alternatives which may not generate the same combustion byproducts as conventional hydrocarbon-based fuels. The use of hydrogen and/or methane, as a gas turbine fuel source, may require very high efficiency propulsion, in order to keep the volume of the fuel low enough to feasibly carry on an aircraft. That is, because of the added weight associated with such liquid/compressed/supercritical fuels, such as related to vessels/containers and the amount (volume) of fuel required, improved efficiencies associated with operation of the gas turbine engine may be necessary.

### BRIEF SUMMARY

According to some embodiments, aircraft engines are provided. The aircraft engines include a core assembly having a compressor section, a burner section, and a turbine section arranged along a shaft, with a core flow path through the turbine engine such that exhaust from the burner section passes through the turbine section. A core condenser is arranged downstream of the turbine section of the core assembly along the core flow path, the core condenser configured to condense water from the core flow path. A refrigeration system is operably coupled to the core condenser and configured to direct a cold stream flow path into thermal interaction with the core flow path at the core condenser and configured to control a delta temperature at which heat exchange occurs between the core flow path and the cold stream flow path.

In addition to one or more of the features described above, or as an alternative, embodiments of the aircraft engines may include that the refrigeration system comprises a closed-loop refrigeration system.

In addition to one or more of the features described above, or as an alternative, embodiments of the aircraft engines may include that the closed-loop refrigeration system comprises a refrigeration evaporator thermally connected to the core condenser and a refrigeration condenser of the refrigeration system, wherein the refrigeration condenser is at least partially arranged within the cold stream flow path.

In addition to one or more of the features described above, or as an alternative, embodiments of the aircraft engines may include that the closed-loop refrigeration system further comprises a refrigeration compressor arranged between the refrigeration evaporator and the refrigeration condenser and configured to increase a pressure of a refrigerant prior to entering the refrigeration condenser.

In addition to one or more of the features described above, or as an alternative, embodiments of the aircraft engines may include a power source configured to power operation of the refrigeration compressor.

In addition to one or more of the features described above, or as an alternative, embodiments of the aircraft engines may include that the closed-loop refrigeration system further comprises a refrigeration expander arranged between the refrigeration compressor and the refrigeration evaporator and configured to expand a refrigerant prior to entering the refrigeration evaporator.

In addition to one or more of the features described above, or as an alternative, embodiments of the aircraft engines may include that the closed-loop refrigeration system further comprises a refrigeration system core condenser thermally coupling the core flow path and the cold stream flow path, wherein the refrigeration system core condenser is arranged upstream from the core condenser along the core flow path and upstream of a refrigeration condenser of the refrigeration system along the cold stream flow path.

In addition to one or more of the features described above, or as an alternative, embodiments of the aircraft engines may include that the closed-loop refrigeration system further comprises a refrigeration system core condenser thermally coupling the core flow path and the cold stream flow path, wherein the cold stream flow path comprises a first cold stream flow path and a second cold stream flow path, wherein the first cold stream flow path is directed through the refrigeration condenser and the second cold stream flow path is directed through the refrigeration system core condenser.

In addition to one or more of the features described above, or as an alternative, embodiments of the aircraft engines may include that a first cold source configured to supply cold flow into the first cold stream flow path is different from a second cold source configured to supply cold flow into the second cold stream flow path.

In addition to one or more of the features described above, or as an alternative, embodiments of the aircraft engines may include that the refrigeration system comprises an open-loop refrigeration system.

In addition to one or more of the features described above, or as an alternative, embodiments of the aircraft engines may include that the open-loop refrigeration system comprises a refrigeration heat exchanger arranged within the cold stream flow path and a refrigeration turbine configured to receive a flow from the refrigeration heat exchanger to expand a flow thereof and direct said expanded flow to the core condenser.

In addition to one or more of the features described above, or as an alternative, embodiments of the aircraft engines may include that a bleed air flow from the core assembly is extracted from the core flow and directed into the refrigeration heat exchanger.

In addition to one or more of the features described above, or as an alternative, embodiments of the aircraft engines may include that the bleed air flow is extracted from a high pressure compressor of the compressor section of the core assembly.

In addition to one or more of the features described above, or as an alternative, embodiments of the aircraft engines may include that the open-loop refrigeration system further comprises a refrigeration compressor arranged between a bleed extraction point of the core assembly and the refrigeration heat exchanger, the refrigeration compressor configured to increase a pressure of the bleed air flow.

In addition to one or more of the features described above, or as an alternative, embodiments of the aircraft engines may include a power source configured to power operation of the refrigeration turbine.

In addition to one or more of the features described above, or as an alternative, embodiments of the aircraft engines may include that the open-loop refrigeration system further comprises a refrigeration system core condenser thermally coupling the core flow path and the cold stream flow path, wherein the refrigeration system core condenser is arranged upstream from the core condenser along the core flow path and downstream of the refrigeration heat exchanger along the cold stream flow path.

In addition to one or more of the features described above, or as an alternative, embodiments of the aircraft engines may include that the closed-loop refrigeration system further comprises a refrigeration system core condenser thermally coupling the core flow path and the cold stream flow path, wherein the cold stream flow path comprises a first cold stream flow path and a second cold stream flow path, wherein the first cold stream flow path is directed through the refrigeration heat exchanger and the second cold stream flow path is directed through the refrigeration system core condenser.

In addition to one or more of the features described above, or as an alternative, embodiments of the aircraft engines may include at least one temperature sensor arranged to monitor a temperature of the core condenser, at least one temperature sensor arranged to monitor a temperature of the cold stream flow path, and a controller in communication with the temperature sensors and configured to monitor a delta temperature between the core condenser and the cold stream flow path.

In addition to one or more of the features described above, or as an alternative, embodiments of the aircraft engines may include that the controller is configured to increase power to the refrigeration system to maintain a delta temperature of at least 50° F.

According to some embodiments, methods of condensing water from a core flow path of a turbine engine are provided. The methods include detecting a temperature of a core flow passing through a core condenser, detecting a temperature of a cold stream flow, obtaining a delta temperature measurement based on the detected temperature of the core flow and the detected temperature of the cold stream flow, and operating a refrigeration system to maintain a delta temperature at which heat exchange occurs between the core flow and the cold stream flow at, at least, 50°.

The foregoing features and elements may be executed or utilized in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic cross-sectional illustration of a gas turbine engine architecture that may employ various embodiments disclosed herein;

FIG. 2 is a schematic illustration of a turbine engine system in accordance with an embodiment of the present disclosure that employs a non-hydrocarbon fuel source;

FIG. 3 is a schematic diagram of a turbine engine that may incorporate embodiments of the present disclosure;

FIG. 4 is a schematic diagram of a turbine engine having a refrigeration system in accordance with an embodiment of the present disclosure;

FIG. 5 is a schematic diagram of a turbine engine having a refrigeration system in accordance with an embodiment of the present disclosure;

FIG. 6 is a schematic diagram of a turbine engine having a refrigeration system in accordance with an embodiment of the present disclosure;

FIG. 7 is a schematic diagram of a turbine engine having a refrigeration system in accordance with an embodiment of the present disclosure; and

FIG. 8 is a schematic diagram of a turbine engine having a refrigeration system in accordance with an embodiment of the present disclosure.

### DETAILED DESCRIPTION

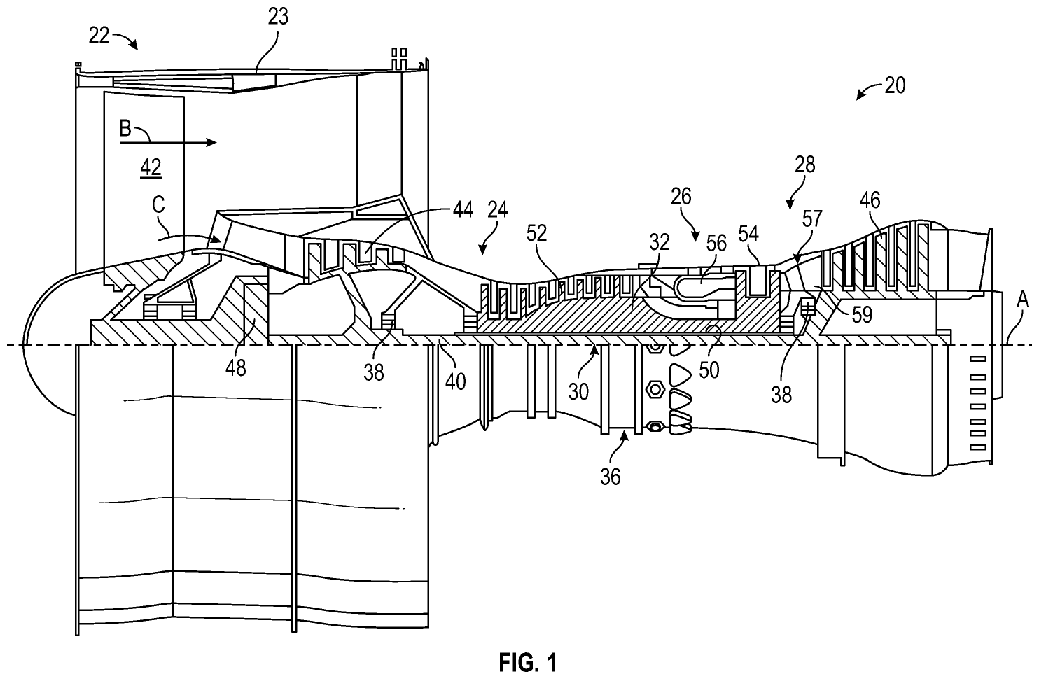

FIG. 1 schematically illustrates a gas turbine engine 20. As illustratively shown, the gas turbine engine 20 is configured as a two-spool turbofan that has a fan section 22, a compressor section 24, a combustor section 26, and a turbine section 28. The illustrative gas turbine engine 20 is merely for example and discussion purposes, and those of skill in the art will appreciate that alternative configurations of gas turbine engines may employ embodiments of the present disclosure. The fan section 22 includes a fan 42 that is configured to drive air along a cold stream flow path B in a bypass duct defined in a fan case 23. The fan 42 is also configured to drive air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines.

In this two-spool configuration, the gas turbine engine 20 includes a low speed spool 30 and a high speed spool 32 mounted for rotation about an engine central longitudinal axis A relative to an engine static structure 36 via one or more bearing systems 38. It should be understood that various bearing systems 38 at various locations may be provided, and the location of bearing systems 38 may be varied as appropriate to a particular application and/or engine configuration.

The low speed spool 30 includes an inner shaft 40 that interconnects the fan 42 of the fan section 22, a first (or low) pressure compressor 44, and a first (or low) pressure turbine 46. The inner shaft 40 is connected to the fan 42 through a speed change mechanism, which, in this illustrative gas turbine engine 20, is as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in the combustor section 26 between the high pressure compressor 52 and the high pressure turbine 54. A mid-turbine frame 57 of the engine static structure 36 is arranged between the high pressure turbine 54 and the low pressure turbine 46. The mid-turbine frame 57 may be configured to support one or more of the bearing systems 38 in the turbine section 28. The inner shaft 40 and the outer shaft 50 are concentric and rotate via the bearing systems 38 about the engine central longitudinal axis A which is collinear with their longitudinal axes.

The core airflow through core airflow path C is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 (e.g., vanes) which are arranged in the core airflow path C. The turbines 46, 54 rotationally drive the respective low speed spool 30 and high speed spool 32 in response to the expansion of the core airflow. It will be appreciated that each of the positions of the fan section 22, the compressor section 24, the combustor section 26, the turbine section 28, and geared architecture 48 or other fan drive gear system may be varied. For example, in some embodiments, the geared architecture 48 may be located aft of the combustor section 26 or even aft of the turbine section 28, and the fan section 22 may be positioned forward or aft of the location of the geared architecture 48.

The gas turbine engine 20 in one example is a high-bypass geared aircraft engine. In some such examples, the engine 20 has a bypass ratio that is greater than about six (6), with an example embodiment being greater than about ten (10). In some embodiments, the geared architecture 48 is an epicyclic gear train, such as a planetary gear system or other gear system, with a gear reduction ratio of greater than about 2.3 and the low pressure turbine 46 has a pressure ratio that is greater than about five (5). In one non-limiting embodiment, the bypass ratio of the gas turbine engine 20 is greater than about ten (10:1), a diameter of the fan 42 is significantly larger than that of the low pressure compressor 44, and the low pressure turbine 46 has a pressure ratio that is greater than about five (5:1). The low pressure turbine 46 pressure ratio is pressure measured prior to inlet of low pressure turbine 46 as related to the pressure at the outlet of the low pressure turbine 46 prior to an exhaust nozzle. In some embodiments, the geared architecture 48 may be an epicycle gear train, such as a planetary gear system or other gear system, with a gear reduction ratio of greater than about 2.3:1. It should be understood, however, that the above parameters are only for example and explanatory of one non-limiting embodiment of a geared architecture engine and that the present disclosure is applicable to other gas turbine engines including turbojets or direct drive turbofans, turboshafts, or turboprops.

A significant amount of thrust is provided by the bypass flow B due to the high bypass ratio. The fan section 22 of the gas turbine engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFC’)”—is the industry standard parameter of 1 bm of fuel being burned divided by 1 bf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]\hat{ }0.5. The “Low corrected fan tip speed” as disclosed herein according to one non-limiting embodiment is less than about 1150 ft/second (350.5 meters/second).

Gas turbine engines generate substantial amounts of heat that is exhausted from the turbine section 28 into a surrounding atmosphere. This expelled exhaust heat represents wasted energy and can be a large source of inefficiency in gas turbine engines. Further, transitioning away from hydrocarbon-based engines may be significant advantages, as described herein.

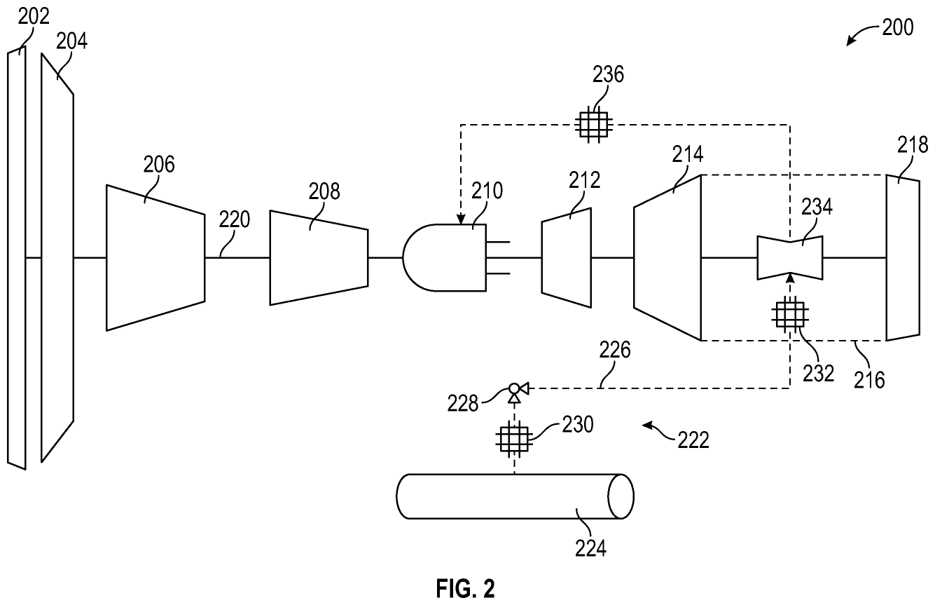

Turning now to FIG. 2, a schematic diagram of a turbine engine system 200 in accordance with an embodiment of the present disclosure is shown. The turbine engine system 200 may be similar to that shown and described above but is configured to employ a non-hydrocarbon fuel source, such as a cryogenic fuel, including but not limited to hydrogen. The turbine engine system 200 includes an inlet 202, a fan 204, a low pressure compressor 206, a high pressure compressor 208, a combustor 210, a high pressure turbine 212, a low pressure turbine 214, a core nozzle 216, and an outlet 218. A core flow path is defined through, at least, the compressor 206,208, the turbine 212, 214, and the combustor sections 210. The compressor 206, 208, the turbine 212, 214, and the fan 204 are arranged along a shaft 220.

As shown, the turbine engine system 200 includes a cryogenic fuel system 222. The cryogenic fuel system 222 is configured to supply a cryogenic fuel from a cryogenic fuel tank 224 to the combustor 210 for combustion thereof. In this illustrative embodiment, the cryogenic fuel may be supplied from the cryogenic fuel tank 224 to the combustor 210 through a fuel supply line 226. The fuel supply line 226 may be controlled by a flow controller 228 (e.g., pump(s), valve(s), or the like). The flow controller 228 may be configured to control a flow through the fuel supply line 226 based on various criteria as will be appreciated by those of skill in the art. For example, various control criteria can include, without limitation, target flow rates, target turbine output, cooling demands at one or more heat exchangers, target flight envelopes, etc.

As shown, between the cryogenic fuel tank 224 and the flow controller 228 may be one or more heat exchangers 230, which can be configured to provide cooling to various systems onboard an aircraft by using the cryogenic fuel (e.g., liquid hydrogen) as a cold-sink. Such hydrogen heat exchangers 230 may be configured to warm the hydrogen and aid in a transition from a liquid state to a supercritical fluid or gaseous state for combustion within the combustor 210. The heat exchangers 230 may receive the hydrogen fuel directly from the cryogenic fuel tank 224 as a first working fluid and a component-working fluid for a different onboard system. For example, the heat exchanger 230 may be configured to provide cooling to power electronics of the turbine engine system 200 (or other aircraft power electronics). In other embodiments, the arrangement of the heat exchanger 230 and the flow controller 228 (or a flow controller element, such as a pump) may be reversed. In some such embodiments, a pump, or other means to increase a pressure of the hydrogen sourced from the cryogenic fuel tank 224, may be arranged upstream of the heat exchanger 230. This pumping or pressure increase may be provided to pump the hydrogen to high pressure as a liquid (low power). It will be appreciated that other configurations and arrangements are possible without departing from the scope of the present disclosure.

In some non-limiting embodiments, an optional secondary fluid circuit may be provided for cooling one or more aircraft loads. In this secondary fluid circuit, a secondary fluid may be configured to deliver heat from the one or more aircraft loads to one or more liquid hydrogen heat exchanger. As such, heating of the hydrogen and cooling of the secondary fluid may be achieved. The above described configurations and variations thereof may serve to begin raising a temperature of the hydrogen fuel to a desired temperature for efficient combustion in the combustor 210.

The hydrogen may then pass through an optional supplemental heating heat exchanger 236. The supplemental heating heat exchanger 236 may be configured to receive hydrogen as a first working fluid and as the second working fluid may receive one or more aircraft system fluids, such as, without limitation, engine oil, environmental control system fluids, pneumatic off-takes, or cooled cooling air fluids. As such, the hydrogen will be heated, and the other fluid may be cooled. The hydrogen will then be injected into the combustor 210 through one or more hydrogen injectors, as will be appreciated by those of skill in the art.

When the hydrogen is directed along the flow supply line 226, the hydrogen can pass through a core flow path heat exchanger 232 (e.g., an exhaust waste heat recovery heat exchanger) or other type of heat exchanger. In this embodiment, the core flow path heat exchanger 232 is arranged in the core flow path downstream of the combustor 210, and in some embodiments, downstream of the low pressure turbine 214. In this illustrative embodiment, the core flow path heat exchanger 232 is arranged downstream of the low pressure turbine 214 and at or proximate the core nozzle 216 upstream of the outlet 218. As the hydrogen passes through the core flow path heat exchanger 232, the hydrogen will pick up heat from the exhaust of the turbine engine system 200. As such, the temperature of the hydrogen will be increased.

The heated hydrogen may then be passed into an expansion turbine 234. As the hydrogen passes through the expansion turbine 234 the hydrogen will be expanded. The process of passing the hydrogen through the expansion turbine 234 cools the hydrogen and extracts useful power through the expansion process. Because the hydrogen is heated from a cryogenic or liquid state in the cryogenic fuel tank 224 through the various mechanisms along the flow supply line 226, engine thermals may be improved.

The use of hydrogen fuel in a gas turbine engine (e.g., in combustion) causes the generation of water. In such systems, steam capture may provide benefits, but condenser pressure loss may be prohibitive to capitalize on capturing steam from the exhaust. Embodiments of the present disclosure are directed to condensing steam from an exhaust stream without or with minimal fan duct pressure losses, thus engine efficiency may be maintained while steam capture is provided. Hydrogen-powered engines can produce more than twice the water vapor than Jet-A-powered engines. Such hydrogen-powered systems may have smaller core sizes, making the trade of steam capture more favorable on hydrogen-powered engines. Steam can be condensed with a cold source, such as fan air, but fan air through a large condenser incurs significant drag. Such penalty in drag due to a large condenser could result in a 10-20% overall efficiency penalty. Most of the heat must be rejected during condensation, which is very close to the fan air temperature. This difficulty in rejecting heat can require the heat exchanger to be very large, and thus it may be difficult to implement such configurations on aircraft (and engines thereof) that are subject to and highly impacted by weight and/or volume limitations. For example, small changes in weight or volume can result in dramatic fuel savings and efficiencies associated with flight propulsion. It will be appreciated that all engines with steam capture capability would benefit significantly from reducing condenser drag.

As noted, steam capture may be beneficial for hydrogen engines, but steam condensation typically happens very close to fan air temperatures. Due to this, there is a small delta temperature between the steam and the heat sink when fan air is to be used as the heat sink. A greater delta temperature would achieve greater condensation, but it may be difficult to achieve such increased delta temperatures. Accordingly, one solution is to increase the size of the condenser, which in turn results in increased weight, volume, and losses. Alternatively, in accordance with some embodiments of the present disclosure, an adjusted heat sink is provided such that the delta temperature is set to be maintained at 20° F. or greater, including ranges of 50° F. or greater, 100° F. or greater, etc.

In view of this and other considerations, embodiments of the present disclosure are directed to incorporating a refrigeration system configured to achieve higher delta temperatures between a core gas flow and a fan gas flow, thus achieving greater condensation capability with smaller condensers. This can result in increased weight and/or volume savings within engines for use onboard aircraft. In accordance with some embodiments of the present disclosure, a closed-loop refrigeration system may be implemented that can result in reduced condenser sizes. In accordance with other embodiments of the present disclosure, an open-loop refrigeration system may be implemented that can result in reduced condenser sizes. In accordance with embodiments of the present disclosure, the size of the condenser is approximately inversely proportional to the temperature difference (delta temperature). As such, by employing embodiments of the present disclosure to increase the delta temperature, a reduced size condenser may be employed. For example, if the delta temperature is doubled, the size of the condenser may be reduced to half. That is, for a given operational and/or environmental condition, a system incorporating embodiments of the present disclosure may achieve a condenser that is half the weight/size of a similar system that does not include embodiments described herein, if the configuration increases the delta temperature by a factor of two. It is noted that, in some embodiments, this reduction in size/weight of the condenser may be offset, in part, by other structures of the refrigeration system. It is also noted that without such a refrigeration system, it may not be possible to functionally operate a non-refrigerated system when an aircraft is located in a very hot (and dry) environment, where a delta temperature is zero.

The refrigeration systems described herein may be powered systems that are configured to increase the delta temperature between a core flow and a cold sink (fan flow) to increase a condensation efficiency and efficacy. In a closed-loop cycle configuration, a refrigerant can be evaporated through thermal exchange with a core flow and then cycled through a refrigeration condenser arranged in a fan flow where the refrigerant is cooled, and then cycled back to the core flow evaporator. In an open-loop configuration, a portion of upstream, compressed air from the core flow can be cooled with the fan flow and then expanded prior to being supplied to a condenser. This cooled and expanded core flow will result in an increased delta temperature, thus improving condensation within a condenser.

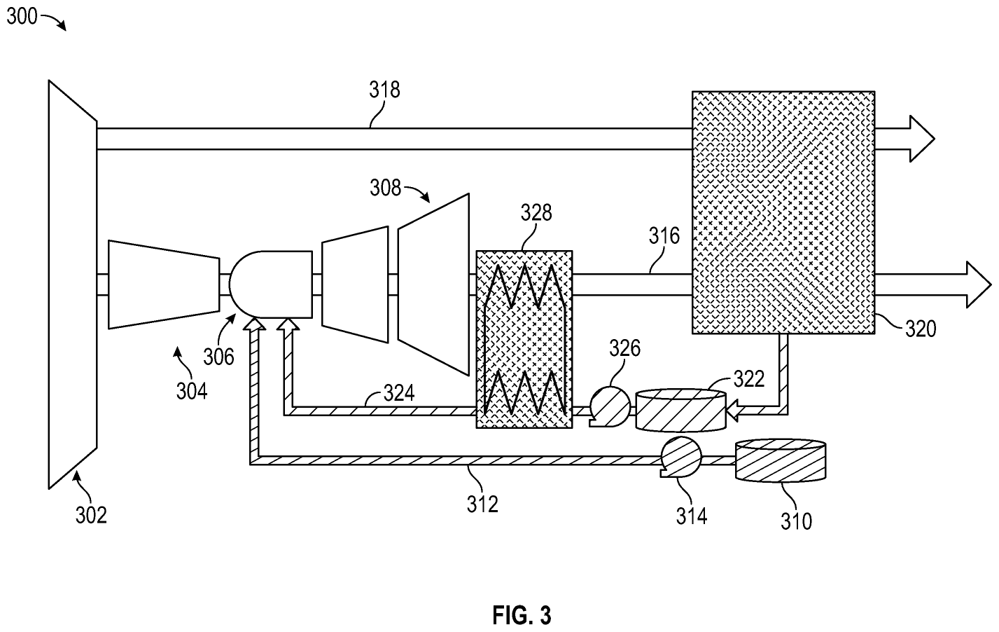

Referring now to FIG. 3, a schematic diagram of a hydrogen combustion engine 300 that can incorporate embodiments of the present disclosure is shown. The hydrogen combustion engine 300 includes a fan section 302, a compressor section 304, a burner section 306, and a turbine section 308. The compressor section 304, the burner section 306, and the turbine section 308 define a Brayton cycle of the engine 300. The burner section 306 includes a combustion chamber configured to mix and burn a fuel, such as hydrogen, the combustion of which generates gaseous water as a byproduct of the combustion operation. The hydrogen fuel is sourced from a cryogenic fuel tank 310. The cryogenic fuel tank 310 is employed to store the hydrogen fuel at cryogenic temperatures in order to reduce the size of the fuel tank. The fuel may be stored as a liquid within the cryogenic fuel tank 310 and converted to a supercritical or gaseous state prior to injection into the burner section 306. The fuel is passed through a fuel line 312 by operation of a pump 314 or the like. The fuel may be passed through various heat exchangers, pumps, or the like (not shown) along the fuel line 312. Such components may be used to alter a temperature and/or pressure of the fuel prior to injection into the burner for combustion.

As shown, a core flow path 316 passes through the engine 300. The core flow path 316 has an inlet at the fan section 302, is compressed within the compressor section 304, mixed with fuel and combusted within the burner section 306, and the hot exhaust from the burner section 306 is passed through the turbine section 308 to extract work therefrom (e.g., drive rotation of an engine shaft). The hot exhaust that is expanded through the turbine section 308 is then directed downstream and exits through an exhaust nozzle (not shown). A second flow of air in the engine 300 bypasses the main core components of the engine 300 through a cold stream flow path 318 (e.g., a bypass flow that bypasses the Brayton cycle of the engine 300 as illustratively shown or a ram flow path, for example). The temperature of the air in the cold stream flow path 318 may be relatively cooler than the core flow, particularly downstream from the burner section 306 (e.g., about 120° F. in the cold stream flow path 318 and about 120-400° F. in the core flow path 316—thus resulting in the delta temperature).

Efficiency of the engine 300 may be improved through water capture from the core flow path 316 which is present as result of the combustion of the hydrogen within with the burner section 306. This captured water may be reinjected into the core flow path as steam to improve efficiency of the combustion operation within the burner section 306. The efficiency improvement may also be driven by increased energy extraction in the turbines due to the presence of water. There may also be improvement due to steam injection that operates as a recuperator (i.e., recovers waste heat and puts it back in at the combustor). It will be appreciated that such captured water may be injected into other locations along the core flow path 316 (e.g., at the compressor section 304 and/or the turbine section 308). A core condenser 320 is arranged downstream along the core flow path 316 from the combustor section 306 to provide water extraction through condensation. In this configuration, a cold sink of the core condenser 320 is provided by the air within the cold stream flow path 318.

As shown, the core condenser 320 is arranged along both the core flow path 316 and the cold stream flow path 318 and the relatively cool air within the cold stream flow path 318 will contrast with the relatively hot air within the core flow path 316 with a delta temperature therebetween. The delta temperature, as referred to herein, may refer to a delta temperature at which heat exchange occurs between the core flow path and the cold stream flow path. Because the delta temperature between the core flow path 316 and the cold stream flow path 318 may be relatively small, to increase condensation of water from the core flow path 316 may require a very large surface area and thus result in a large condenser structure for the core condenser 320. In operation, as the water is condensed at the core condenser 320, the water may be collected into a water tank 322 (e.g., by means of a water separator, water collector, drainage paths, or the like). The collected water may then be pumped along a water line 324 by a water pump 326. It may be advantageous to convert liquid water to steam prior to injection back into the core flow path 316, and thus a core flow evaporator 328 may be arranged within or along the core flow path 316 downstream from the burner section 306. The liquid water from the water tank 322 may be passed through the core flow evaporator 328 where heat is picked up from the combustion byproducts produced in the burner section 306. The water will be evaporated to generate steam (and the temperature of the air in the core flow path 316 will decrease). This steam may then be injected into the burner section 306 and/or other location along the core flow path 316.

As shown, the core condenser 320 spans both the core flow path 316 and the cold stream flow path 318. Further, as noted, the core condenser 320 may require a large volume or surface area to achieve the desired condensation and water capture. This results in a pressure loss within the cold stream flow path 318 and can result in significant drag (e.g., 1,000 lb drag, or greater). This drag can result in significant inefficiencies of the operation of the engine 300. Accordingly, it may be advantageous to increase the delta temperature between the core flow and the bypass flow to achieve greater condensation efficiency within a condenser of the system. For example, in accordance with embodiments of the present disclosure, a delta temperature at which heat exchange occurs between a core flow path and a cold stream flow path may be maintained at, at least, 20° F., 50° F., 100° F. or greater. In some more specific example embodiments, it may be desirable to maintain the delta temperature at which heat exchange between the flows occurs at 50° F. or greater.

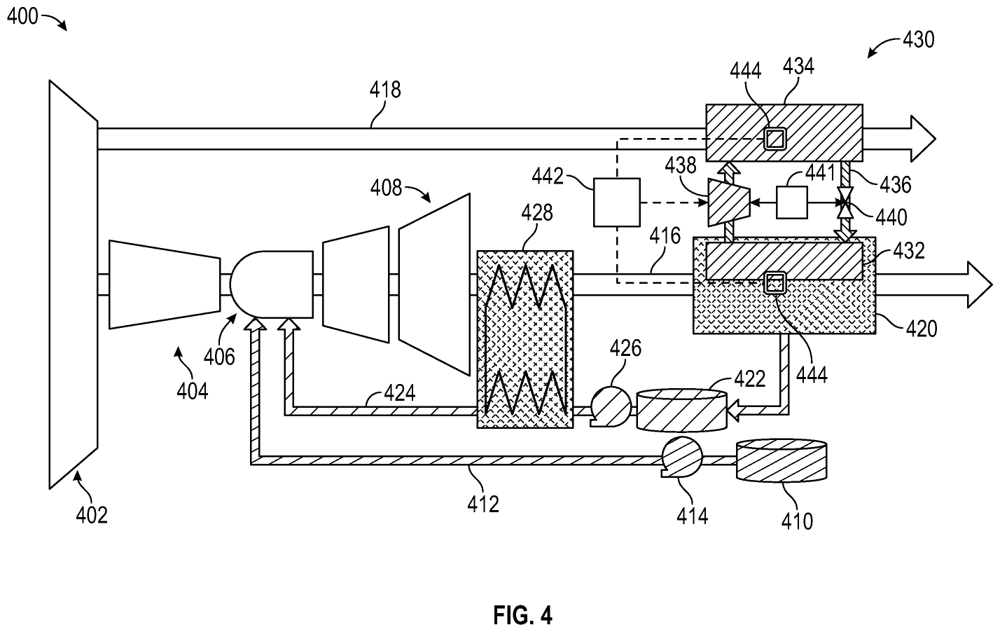

Referring now to FIG. 4, a schematic diagram of a hydrogen combustion engine 400 in accordance with an embodiment of the present disclosure is shown. The hydrogen combustion engine 400 includes a fan section 402, a compressor section 404, a burner section 406, and a turbine section 408, similar to that described above with respect to FIG. 3. Hydrogen fuel for combustion within the burner section 406 is sourced from a cryogenic fuel tank 410. The fuel is passed through a fuel line 412 by operation of a pump 414 or the like. The fuel may be passed through various heat exchangers, pumps, or the like (not shown) along the fuel line 412. Such components may be used to alter a temperature and/or pressure of the fuel prior to injection into the burner section 406 for combustion.

Similar to the configuration of FIG. 3, a core flow path 416 passes through the engine 400 from an inlet at the fan section 402, through the compressor section 404, combusted within the burner section 406, and passed through the turbine section 408 to extract work therefrom. The hot exhaust that is expanded through the turbine section 408 is then directed downstream and exits through an exhaust nozzle (not shown). A second flow of air of the engine 400 is directed through a cold stream flow path 418 which bypasses the main core components of the engine 400.

A core condenser 420 is arranged along the core flow path 416 to condense water from the core flow path 416. In operation, as the water is condensed at the core condenser 420 and collected into a water tank 422 (e.g., by means of a water separator, water collector, drainage paths, or the like). The collected water may then be pumped along a water line 424 by a water pump 426 to be evaporated and/or injected into the core flow path 416 (e.g., at the compressor section 404, the burner section 406, and/or the turbine section 408). As shown, a core flow evaporator 428 is arranged within or along the core flow path 416 downstream from the burner section 406 to generate steam from the collected water.

In this configuration, a refrigeration system 430 is arranged to pump heat from the core flow path 416 that passes through the core condenser 420 to the cold stream flow path 418. As a result, the core condenser 420, in this arrangement, is a power-condenser. In this configuration, a refrigerant of the refrigeration system 430 functions as an intermediate fluid that increase the temperature differences at which heat exchange occurs. For example, the refrigeration system 430 may be configured to maintain a delta temperature of at least 20° F., 50° F., 100° F. or greater for thermal/heat exchanger between flows at the refrigeration evaporator 432 and the core condenser 420, as well as a delta temperature of at least 20° F., 50° F., 100° F. or greater between the flows at the refrigeration condenser 434 and the air of the cold stream flow path 418. In this illustrative configuration, the refrigeration system 430 includes a refrigeration evaporator 432 arranged within or as part of the core condenser 420 and the refrigeration condenser 434 arranged within or as part of the cold stream flow path 418 (e.g., within a bypass duct). A refrigerant is arranged within a closed-loop cycle that passes from the refrigeration evaporator 432 to the bypass refrigeration condenser 434 and back. A refrigerant flow path 436 will direct evaporated or hot refrigerant from the refrigeration evaporator 432 through a refrigeration compressor 438 where the refrigerant is compressed and increased in pressure and then passed into and through the refrigeration condenser 434. The refrigerant will then be cooled through heat pick up by the relatively cool air within the refrigeration condenser 434 and then directed back to the refrigeration evaporator 432 through a refrigeration expander 440, such as an expansion valve or expansion turbine. In some embodiments, the refrigeration expander 440 (e.g., when configured as an expansion turbine) may be operably coupled to the refrigeration compressor 438 and an external power source or power input may be configured to drive operation thereof. In some embodiments, the refrigeration compressor 438 may be a powered device that receive electrical and/or mechanical power from a power source 441, such as a battery, a generator, a mechanical coupling to a shaft of the engine 400, or the like.

In the configuration of the engine 400, heat rejection from the core flow path 416 into the cold stream flow path 418 is achievable by smaller, lower pressure loss heat exchanger when power is supplied to the closed-loop refrigeration cycle of the refrigeration system 430. In accordance with some embodiments, the inclusion of the refrigeration system 430 may achieve weight and/or size reductions of the condenser of a system that did not include such refrigeration system. For example, due to the inverse relationship between the delta temperature and the condenser size, a condenser having half the size of a conventional system may be achieved. This is helpful as the delta temperature from condensation-to-fan air becomes close to zero. Refrigeration cycle work will decrease when sufficient (e.g., larger) delta temperature is available. As such, the refrigeration system 430 may be selectively operated based on a measured delta temperature. Accordingly, the refrigeration system 430 may include a controller 442 and associated sensors 444 for monitoring a temperature of each of the core flow path 416 and the cold stream flow path 418 and monitor the delta temperature therebetween. In some embodiments, the refrigeration system 430 may be operated when the delta temperature is 90° F. or lower. Although described with respect to a cold stream flow path, it will be appreciated that the cold sink of the refrigeration system 430 may be a fan stream (e.g., the illustrated bypass flow) or a ram air stream received from a ram duct on the engine 400. The controller 442 may be configured to control operation of the refrigeration compressor 438 and/or the refrigeration expander 440 to cause cycling of the refrigerant through the refrigerant flow path 436.

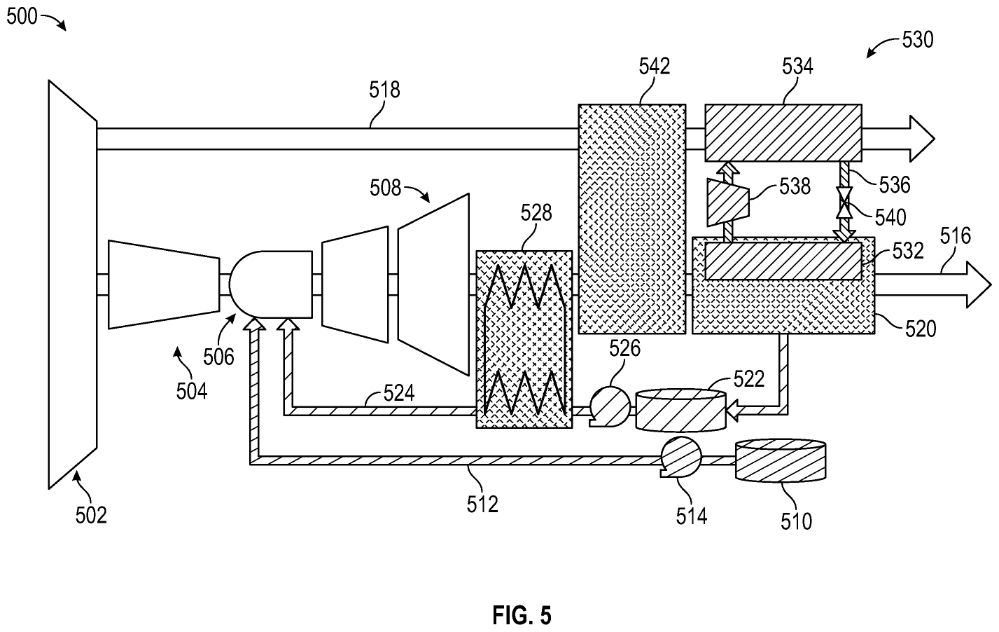

Turning now to FIG. 5, a schematic diagram of a hydrogen combustion engine 500 in accordance with an embodiment of the present disclosure is shown. The hydrogen combustion engine 500 includes a fan section 502, a compressor section 504, a burner section 506, and a turbine section 508, similar to that described above. Hydrogen fuel for combustion within the burner section 506 is sourced from a cryogenic fuel tank 510. The fuel is passed through a fuel line 512 by operation of a pump 514 or the like. The fuel may be passed through various heat exchangers, pumps, or the like (not shown) along the fuel line 512. Such components may be used to alter a temperature and/or pressure of the fuel prior to injection into the burner section 506 for combustion. A core flow path 516 passes from the fan section 502, through the compressor section 504, the burner section 506, and the turbine section 508. A second flow of air of the engine 500 is directed through a cold stream flow path 518 which bypasses the main core components of the engine 500.

A core condenser 520 is arranged along the core flow path 516 to condense water from the core flow path 516. The water is collected into a water tank 522 and then pumped along a water line 524 by a water pump 526 to be evaporated and/or injected into the core flow path 516, as described above. As shown, a core flow evaporator 528 is arranged within or along the core flow path 516 downstream from the burner section 506 to generate steam from the collected water.

In this configuration, a refrigeration system 530 is arranged to pump heat from the core flow path 516 that passes through the core condenser 520 to the cold stream flow path 518. The refrigeration system 530 includes a refrigeration evaporator 532 and a refrigeration condenser 534 similar to the configuration described with respect to FIG. 4. A refrigerant is arranged within a closed-loop cycle that passes from the refrigeration evaporator 532 to the refrigeration condenser 534 and back. A refrigerant flow path 536 will direct the refrigerant from the refrigeration evaporator 532 through a refrigeration compressor 538 and through the refrigeration condenser 534. In this configuration, the refrigerant is an intermediate fluid that increases the temperature difference at which heat exchange occurs. The refrigerant is then directed back to the refrigeration evaporator 532 through a refrigeration expander 540. The refrigeration compressor 538 of the refrigeration system 530 may be a powered component that receives electrical and/or mechanical power to be driven in operation. In this configuration, the refrigeration system 530 further includes a refrigeration system core condenser 542. This refrigeration system core condenser 542 may be similar to the core condenser discussed with respect to FIG. 3, but structurally would be smaller as it is combined in the refrigeration system 530 with the closed-loop refrigeration described above.

The refrigeration system core condenser 542 is arranged, in this embodiment, upstream of the other components of the refrigeration system 530 along both the core flow path 516 and the cold stream flow path 518. The refrigeration system core condenser 542 can provide cooling for condensation of water from the core flow path 516 at all delta temperatures and/or operational conditions of the engine 500. However, this condensing can be supplemented or augmented by a powered solution in the form of the closed-loop refrigeration components that are arranged downstream from the refrigeration system core condenser 542. It will be appreciated that a controller and sensors (e.g., as shown in FIG. 4) can be used to activate the refrigeration compressor 538 and/or refrigeration expander 540 to conduct the refrigerant through the refrigerant flow path 536 and increase a delta temperature to increase condensing of water from the core flow path 516. In some embodiments, a portion of the refrigeration system 530 (e.g., the refrigeration system core condenser 542) may be sized for low capacity or when sufficient delta temperature is expected (e.g., at cruise) while operation of the powered components of the refrigeration system 530 may be used to accommodate smaller delta temperature and ensure sufficiently high delta temperature for condensation to occur efficiently (e.g., at take-off or climb).

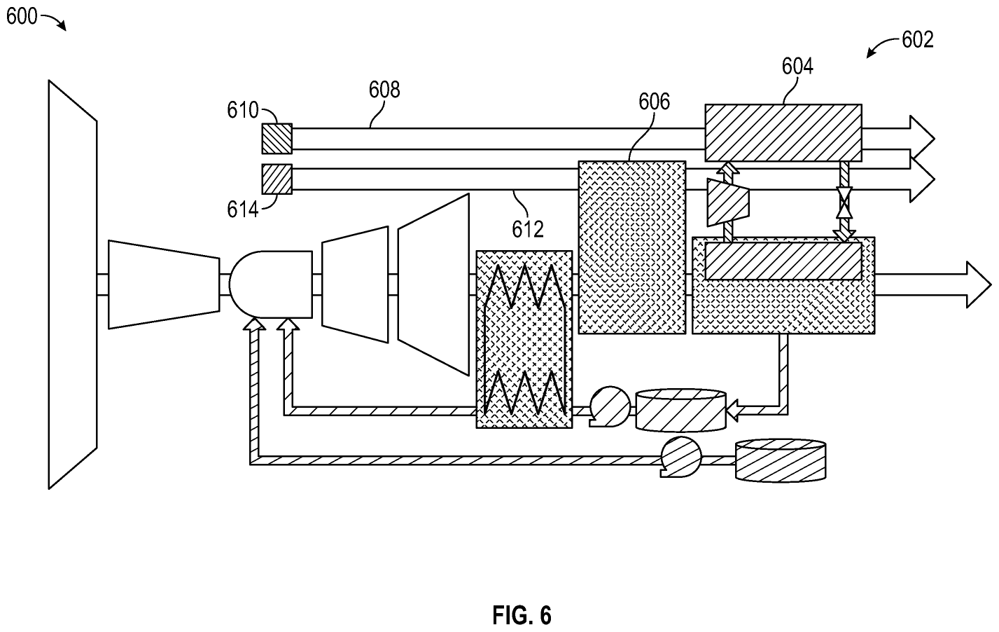

Turning to FIG. 6, a schematic diagram of a hydrogen combustion engine 600 in accordance with an embodiment of the present disclosure is shown. The engine 600 is configured substantially similar to the configuration shown in FIG. 5, having a core assembly of the engine and a condensation system. In this configuration, a refrigeration system 602 includes a refrigeration condenser 604 and a refrigeration system core condenser 606. The refrigeration system 602 is a powered system that receives electrical and/or mechanical power to drive operation of at least a refrigeration compressor of the closed-loop system, with the expander thereof being powered or passive (e.g., expansion valve). FIG. 6 illustrates that the refrigeration condenser 604 and the refrigeration system core condenser 606 can receive different cold streams. That is, as shown, a first cold stream flow path 608 may be directed from a first cold source 610 to the refrigeration condenser 604 and a second cold stream flow path 612 may be directed from a second cold source 614. In some embodiments, the first and second cold sources 610, 614 may be the same source (e.g., a fan section, a ram inlet, or the like). In other embodiments, the two cold sources 610, 614 may be different (e.g., one is a fan section and the other is a ram inlet). It will be appreciated that other cold sources may be employed, without departing from the scope of the present disclosure.

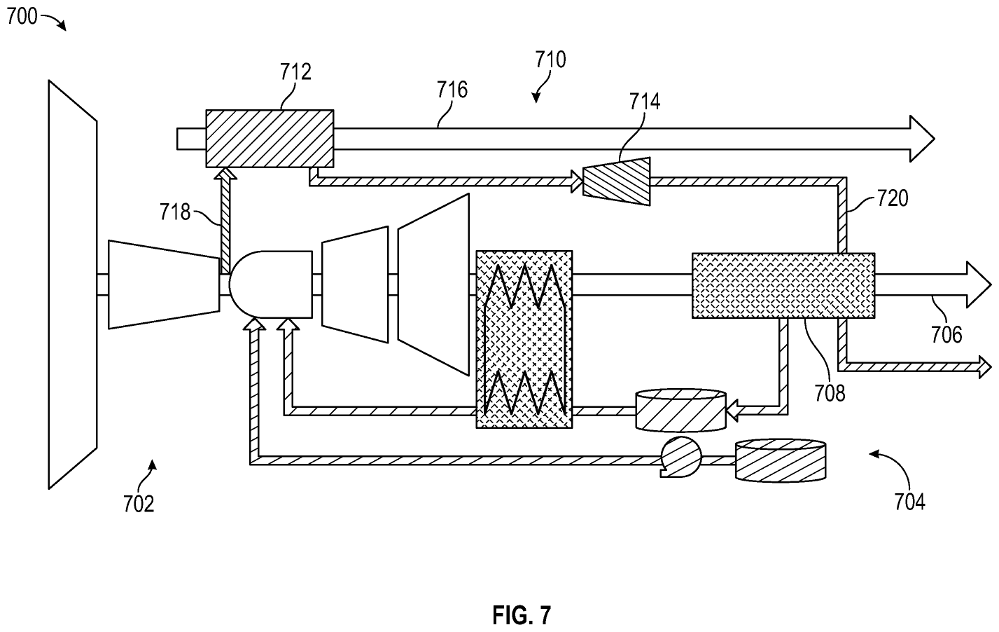

Turning now to FIG. 7, a schematic diagram of a hydrogen combustion engine 700 in accordance with an embodiment of the present disclosure is shown. The engine 700 is configured substantially similar to the configurations shown and described above, and thus similar structures will not be described again. The engine 700 has a core assembly 702 and a hydrogen fuel system 704. A condensing arrangement is provided to condense water from a core flow path 706, including a core condenser 708 as described above. In this configuration, a refrigeration system 710 includes a refrigeration heat exchanger 712 and a refrigeration turbine 714. The refrigeration turbine 714 may power an electric generator or may be mechanically couple to the main shaft. The refrigeration heat exchanger 712 is arranged in a cold source duct 716 (e.g., fan bypass, ram duct, etc.). The increased delta temperature at the core condenser 708 is achieved by passing a portion of bleed air 718 from the core assembly 702 through the refrigeration heat exchanger 712 and expanded in the refrigeration turbine 714 and then passed through the core condenser 708. As such, a relatively cold flow 720 can be passed through the core condenser 708 to cause condensation of water within the core flow path 706.

In operation, the bleed air 718 may be extracted from any location upstream of the combustor section of the core assembly 702. In some embodiments, it may be preferred to extract the highest pressure air, and thus the bleed air 718 may be extracted from a high pressure compressor of the core assembly. The high pressure bleed air is directed into the refrigeration heat exchanger 712 where cold air within the cold source duct 716 will operate as a heat sink. The cooled, high pressure bleed air will then be expanded as it passes through the refrigeration turbine 714. The expanded cold air will have a greater capacity for thermal exchange and thus increase delta temperature as the cold air passes through the core condenser 708. As such, the condensing efficiency of the core condenser 708 may be increased allowing for a smaller core condenser than in engines that do not include refrigeration systems as described herein.

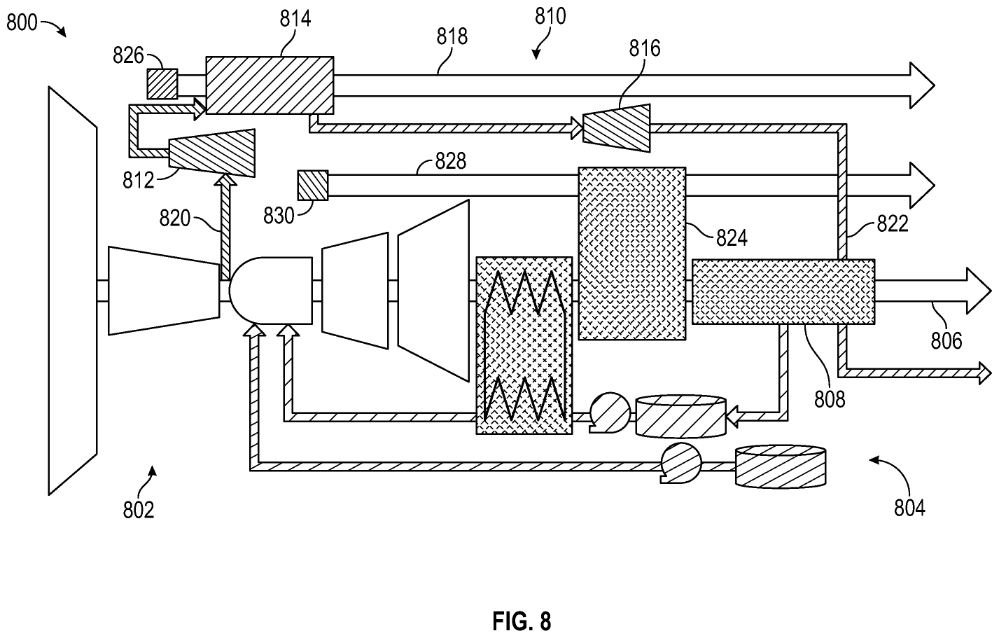

Turning now to FIG. 8, a schematic diagram of a hydrogen combustion engine 800 in accordance with an embodiment of the present disclosure is shown. The engine 800 is configured substantially similar to the configurations shown and described above, and thus similar structures will not be described again. The engine 800 has a core assembly 802 and a hydrogen fuel system 804. A condensing arrangement is provided to condense water from a core flow path 806, including a core condenser 808 as described above. In this configuration, a refrigeration system 810 includes a refrigeration compressor 812, refrigeration heat exchanger 814, and a refrigeration turbine 816. The refrigeration compressor 812 and the refrigeration turbine 816 may be powered components (e.g., electrically or mechanically powered) using a power source as described above. In some embodiments, the refrigeration compressor 812 and the refrigeration turbine 816 may be operably coupled to and driven by a dedicated or independent drive shaft. The refrigeration heat exchanger 814 is arranged in a first cold stream flow path 818 (e.g., fan bypass, ram duct, etc.). The increased delta temperature at the core condenser 808 is achieved by passing a portion of bleed air 820 from the core assembly 802. The bleed air 820 is further increased in pressure through the refrigeration compressor 812 and then directed through the refrigeration heat exchanger 814 and expanded in the refrigeration turbine 816 and then passed through the core condenser 808. As such, a relatively cold flow 822 can be passed through the core condenser 808 to cause condensation of water within the core flow path 806.

Similar to the embodiments of FIGS. 5-6, the engine 800 includes a refrigeration system core condenser 824 that can provide cooling using non-precooled air whereas the other components of the refrigeration system 810 provide cooling using other components to pre-cool the air. FIG. 8 illustrates that the refrigeration heat exchanger 814 and the refrigeration system core condenser 824 can receive different cold streams. That is, as shown, a first cold stream flow path 818 may be directed from a first cold source 826 to the refrigeration heat exchanger 814 and a second cold stream flow path 828 may be directed from a second cold source 830 to the refrigeration system core condenser 824. In some embodiments, the first and second cold sources 826, 830 may be the same source (e.g., a fan section, a ram inlet, or the like). In other embodiments, the two cold sources 826, 830 may be different (e.g., one is a fan section and the other is a ram inlet or a different stream in the fan section). It will be appreciated that other cold sources may be employed, without departing from the scope of the present disclosure.

In accordance with embodiments of the present disclosure, refrigeration systems (closed-loop or open-loop) are integrated into turbine engines to provide improved condensation of water from a core flow. The refrigeration systems are powered systems that include one or more powered components (e.g., turbines, compressors, expanders, etc.) that are configured to increase a delta temperature between a core flow flowing through a core condenser and a cooling flow that causes condensation of the water from the flow. The power provided to these components of the refrigeration systems may be sourced from various different sources onboard an aircraft and/or engine. In some embodiments, the powered components of the refrigeration systems of the present disclosure are configured to receive electrical and/or mechanical power from a power source, such as a battery, a generator, a mechanical coupling to a shaft of the engine.

In the open-loop configurations of embodiments of the present disclosure (e.g., FIGS. 7-8), the cold flow 720, 822 that is passed through the core condenser 708, 808 may be dumped overboard from the engine. However, in other embodiments, this cold flow can be further used onboard the aircraft and/or onboard the engine itself. For example, the cold flow may be directed to various systems to provide cooling for engine oil, electric motors/generators, gearboxes/purge air, and other systems that may not require highly pressurized air. Further, such cold flow may be directed from the core condenser to an environmental control system of the aircraft for use therein.

As described herein, embodiments of the present disclosure are directed to systems and processes for maintaining appropriate temperatures of various flows to ensure efficient thermal exchange therebetween. The temperatures may be controlled (e.g., through cooling mechanisms) to ensure that a delta temperature of thermal exchange between a (hot) core stream flow and a refrigeration evaporator is maintained at, at least, 20° F., 50° F., 100° F. or greater. In some embodiments, it may be desirable to maintain such heat exchange at a delta temperature of 50° F. or greater. Further, the delta temperature may be based upon a difference between a refrigeration condenser and a cold stream (e.g., fan stream), and similar temperature differences (e.g., at least 20° F., 50° F., 100° F. or greater) may be preferred. In some such embodiments, a delta temperature of 50° F. or greater is ensured by operation of the refrigeration systems described herein. Similar temperature differences may be monitored and maintained between a refrigeration heat exchanger and a cold stream flow (e.g., fan stream) and/or a core condenser and a cold stream flow (e.g., fan stream).

Advantageously, in accordance with embodiments of the present disclosure, improved condensation of water from a core flow of a turbine engine is provided. The improved condensation is achieved through controlling and augmenting a cold sink passing through a core condenser to achieve improved delta temperature between the core flow and a cold flow through the core condenser. Advantageously, through such refrigeration systems, pressure losses in bypass flows or the like may be mitigated. Further, such refrigeration systems allow for smaller core condensers, thus saving volume and/or weight on the engines. Additionally, in accordance with some embodiments, cooling air that is passed through a core condenser may also be subsequently directed to other systems of an engine and/or aircraft.

As used herein, the terms “about” and “substantially” are intended to include the degree of error associated with measurement of the particular quantity based upon the equipment available at the time of filing the application. For example, “about” or “substantially” may include a range of ±8%, or 5%, or 2% of a given value or other percentage change as will be appreciated by those of skill in the art for the particular measurement and/or dimensions referred to herein. The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof. It should be appreciated that relative positional terms such as “forward,” “aft,” “upper,” “lower,” “above,” “below,” “radial,” “axial,” “circumferential,” and the like are with reference to normal operational attitude and should not be considered otherwise limiting.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description but is only limited by the scope of the appended claims.

What is claimed is:

1. An aircraft engine, comprising:
a core assembly comprising a compressor section, a burner section, and a turbine section arranged along a shaft, with a core flow path through the turbine engine such that exhaust from the burner section passes through the turbine section;
a core condenser arranged downstream of the turbine section of the core assembly along the core flow path, the core condenser configured to condense water from the core flow path; and
a refrigeration system operably coupled to the core condenser and configured to direct a cold stream flow path into thermal interaction with the core flow path at the core condenser and configured to control a delta temperature at which heat exchange occurs between the core flow path and the cold stream flow path.

2. The aircraft engine of claim 1, wherein the refrigeration system comprises a closed-loop refrigeration system.

3. The aircraft engine of claim 2, wherein the closed-loop refrigeration system comprises a refrigeration evaporator thermally connected to the core condenser and a refrigeration condenser of the refrigeration system, wherein the refrigeration condenser is at least partially arranged within the cold stream flow path.

4. The aircraft engine of claim 3, wherein the closed-loop refrigeration system further comprises a refrigeration compressor arranged between the refrigeration evaporator and the refrigeration condenser and configured to increase a pressure of a refrigerant prior to entering the refrigeration condenser.

5. The aircraft engine of claim 4, further comprising a power source configured to power operation of the refrigeration compressor.

6. The aircraft engine of claim 3, wherein the closed-loop refrigeration system further comprises a refrigeration expander arranged between the refrigeration compressor and the refrigeration evaporator and configured to expand a refrigerant prior to entering the refrigeration evaporator.

7. The aircraft engine of claim 2, wherein the closed-loop refrigeration system further comprises a refrigeration system core condenser thermally coupling the core flow path and the cold stream flow path, wherein the refrigeration system core condenser is arranged upstream from the core condenser along the core flow path and upstream of a refrigeration condenser of the refrigeration system along the cold stream flow path.

8. The aircraft engine of claim 2, wherein the closed-loop refrigeration system further comprises a refrigeration system core condenser thermally coupling the core flow path and the cold stream flow path, wherein the cold stream flow path comprises a first cold stream flow path and a second cold stream flow path, wherein the first cold stream flow path is directed through the refrigeration condenser and the second cold stream flow path is directed through the refrigeration system core condenser.

9. The aircraft engine of claim 8, wherein a first cold source configured to supply cold flow into the first cold stream flow path is different from a second cold source configured to supply cold flow into the second cold stream flow path.

10. The aircraft engine of claim 1, wherein the refrigeration system comprises an open-loop refrigeration system.

11. The aircraft engine of claim 10, wherein the open-loop refrigeration system comprises a refrigeration heat exchanger arranged within the cold stream flow path and a refrigeration turbine configured to receive a flow from the refrigeration heat exchanger to expand a flow thereof and direct said expanded flow to the core condenser.

12. The aircraft engine of claim 11, wherein a bleed air flow from the core assembly is extracted from the core flow and directed into the refrigeration heat exchanger.

13. The aircraft engine of claim 12, wherein the bleed air flow is extracted from a high pressure compressor of the compressor section of the core assembly.

14. The aircraft engine of claim 12, wherein the open-loop refrigeration system further comprises a refrigeration compressor arranged between a bleed extraction point of the core assembly and the refrigeration heat exchanger, the refrigeration compressor configured to increase a pressure of the bleed air flow.

15. The aircraft engine of claim 11, further comprising a power source configured to power operation of the refrigeration turbine.

16. The aircraft engine of claim 11, wherein the open-loop refrigeration system further comprises a refrigeration system core condenser thermally coupling the core flow path and the cold stream flow path, wherein the refrigeration system core condenser is arranged upstream from the core condenser along the core flow path and downstream of the refrigeration heat exchanger along the cold stream flow path.

17. The aircraft engine of claim 11, wherein the closed-loop refrigeration system further comprises a refrigeration system core condenser thermally coupling the core flow path and the cold stream flow path, wherein the cold stream flow path comprises a first cold stream flow path and a second cold stream flow path, wherein the first cold stream flow path is directed through the refrigeration heat exchanger and the second cold stream flow path is directed through the refrigeration system core condenser.

18. The aircraft engine of claim 1, further comprising:
at least one temperature sensor arranged to monitor a temperature of the core condenser;
at least one temperature sensor arranged to monitor a temperature of the cold stream flow path; and
a controller in communication with the temperature sensors and configured to monitor a delta temperature between the core condenser and the cold stream flow path.

19. The aircraft engine of claim 18, wherein the controller is configured to increase power to the refrigeration system to maintain a delta temperature of at least 50° F.

20. A method of condensing water from a core flow path of a turbine engine, the method comprising:
detecting a temperature of a core flow passing through a core condenser;
detecting a temperature of a cold stream flow;
obtaining a delta temperature measurement based on the detected temperature of the core flow and the detected temperature of the cold stream flow; and
operating a refrigeration system to maintain a delta temperature at which heat exchange occurs between the core flow and the cold stream flow at, at least, 50° F.
